(19) United States
(12) Patent Application Publication
(10) Pub. No.: US 2026/0255116 A1
(43) Pub. Date: Aug. 27, 2026

(54) AUDIO DEVICE, SIGNAL PROCESSING METHOD, AND DISPLAY METHOD

(71) Applicant: SONY GROUP CORPORATION, TOKYO (JP)

(72) Inventors: GO IGARASHI, TOKYO (JP); YOSHIYUKI KURODA, TOKYO (JP); NAOKI SHINMEN, TOKYO (JP); YUTA SATO, TOKYO (JP)

(21) Appl. No.: 19/162,553

(22) PCT Filed: Mar. 6, 2024
(86) PCT No.: PCT/JP2024/008526

§ 371 Date: Sep. 5, 2025

(30) Foreign Application Priority Data
Mar. 23, 2023 (JP) 2023-046359

(51) Int. Cl. H04R 29/00; H04R 3/02; H04R 9/02; H04R 9/06

(52) U.S. Cl. CPC H04R 29/003; H04R 3/02; H04R 9/025; H04R 9/06; H04R 2209/041

(57) ABSTRACT

An audio device includes a diaphragm, a movable unit that includes a coil and connects with the diaphragm, and a magnetic circuit unit that includes a magnet and a yoke and generates magnetic force acting on the coil. The magnetic circuit unit includes a top plate portion that constitutes a part of the yoke and has a top surface portion located above the magnet and extending in a direction substantially perpendicular to a movable direction of the movable unit. The top plate portion has a protrusion portion that protrudes downward from an inner edge or an outer edge of the top surface portion. The movable unit has a first coil and a second coil each constituting the coil. Winding portions of the first coil and the second coil of the movable unit face a protruding side surface that is a side surface of the top plate portion on a side where the protrusion portion is formed.

### TECHNICAL FIELD

The present technology relates to an audio device such as a speaker and a microphone, a signal processing method for an audio device, and a display method for displaying information regarding an audio device.

### BACKGROUND ART

Some types of audio devices conventionally known, such as dynamic speakers and microphones, each include a movable unit which has a coil and connects with a diaphragm and a magnetic circuit unit which has a magnet and a yoke and generates magnetic force acting on the coil. These audio devices will hereinafter be referred to as “movable coil-type” audio devices.

Among the movable coil-type audio devices, there are known such audio devices which constitute speakers and perform MFB (Motional Feed-Back) control for reducing distortion produced during loud-volume reproduction or in other situations (for example, see PTL 1 and PTL 2 identified below). As disclosed in PTL 1 and PTL 2, for achieving MFB control, a driving coil for driving a diaphragm and a sensing coil for detecting movement of the diaphragm are provided on a movable unit connected to the diaphragm, to perform signal processing for distortion correction of audio signals according to electric signals of the sensing coil.

### CITATION LIST

### Patent Literature

### [PTL 1]

Japanese Patent Laid-open No. Hei07-059188

### [PTL 2]

Japanese Patent Laid-open No. Hei09-284887

### SUMMARY

### Technical Problem

Similarly to the speaker performing MFB control noted above, the movable coil-type audio devices may each include multiple coils for the movable unit.

According to PTL 1 having this configuration, the sensing coil is provided separately from the driving coil and wound around a bobbin different from a bobbin of the driving coil. In addition, a magnetic circuit provided for the sensing coil includes a magnet and a yoke (including a plate) dedicated to the magnetic circuit. In other words, a set of the magnet and the yoke is provided for each of the driving coil and the sensing coil.

Meanwhile, according to PTL 2, the sensing coil is provided separately from the driving coil, and a set of the magnet and the yoke is provided for each of the driving coil and the sensing coil as in PTL 1.

However, the configuration including the set of the magnet and the yoke for each of the coils as described above increases each size and weight of the audio devices. Particularly, because of this size and weight increase, the configuration including the multiple coils is difficult to apply to small-sized audio devices such as earphones and headphones.

The present technology has been developed in consideration of the abovementioned circumstances. An object of the present technology is to reduce a size increase and a weight increase of a movable coil-type audio device which includes multiple coils for a movable unit.

### Solution to Problem

A first audio device according to the present technology includes a diaphragm, a movable unit that includes a coil and connects with the diaphragm, and a magnetic circuit unit that includes a magnet and a yoke and generates magnetic force acting on the coil. The magnetic circuit unit includes a top plate portion that constitutes a part of the yoke and has a top surface portion located above the magnet and extending in a direction substantially perpendicular to a movable direction of the movable unit. The top plate portion has a protrusion portion that protrudes downward from an inner edge or an outer edge of the top surface portion. The movable unit has a first coil and a second coil each constituting the coil. Winding portions of the first coil and the second coil of the movable unit face a protruding side surface that is a side surface of the top plate portion on a side where the protrusion portion is formed.

As described above, the protrusion portion is provided on the top plate portion, and the winding portions of the first coil and the second coil of the movable unit face the protruding side surface of the top plate portion. In this case, respective magnetic circuits for the first coil and the second coil can be formed by use of a common magnet and a common yoke. In other words, a necessity of providing a magnet and a yoke for each of the coils can be eliminated.

Further, a second audio device according to the present technology includes a diaphragm, a movable unit that includes a driving coil for driving the diaphragm and a sensing coil for detecting movement of the diaphragm and connects with the diaphragm, a magnetic circuit unit that includes a magnet and a yoke and generates magnetic force acting on the driving coil and magnetic force acting on the sensing coil, and an electric circuit unit that generates a driving signal of the driving coil according to a sensing signal generated by the sensing coil. The electric circuit unit includes a feedback control unit that has a feedback loop for processing an audio signal according to the sensing signal and a feedforward control unit that performs arithmetic processing using a predetermined coefficient for the audio signal input to the feedback loop.

This configuration includes the feedforward control unit in addition to the feedback control unit which performs feedback control according to sensing signals of the sensing coil as in conventional MFB control. Accordingly, distortion not corrected by the feedback control unit alone is correctable.

Further, a signal processing method according to the present technology is a signal processing method for an audio device that includes a diaphragm, a movable unit that includes a driving coil for driving the diaphragm and a sensing coil for detecting movement of the diaphragm and connects with the diaphragm, a magnetic circuit unit that includes a magnet and a yoke and generates magnetic force acting on the driving coil and magnetic force acting on the sensing coil, and an electric circuit unit that generates a driving signal of the driving coil according to a sensing signal generated by the sensing coil. The electric circuit unit performs feedback control that processes an audio signal by using a feedback loop to which the sensing signal is input and feedforward control that performs arithmetic processing using a predetermined coefficient for the audio signal input to the feedback loop.

The signal processing method described above can achieve operations similar to those of the second audio device described above.

In addition, a display method according to the present technology is a display method for an audio device that includes a diaphragm, a movable unit that includes a coil and connects with the diaphragm, and a magnetic circuit unit that includes a magnet and a yoke and generates magnetic force acting on the coil. The magnetic circuit unit includes a top plate portion that constitutes a part of the yoke and has a top surface portion located above the magnet and extending in a direction substantially perpendicular to a movable direction of the movable unit. The top plate portion has a protrusion portion that protrudes downward from an inner edge or an outer edge of the top surface portion. The movable unit includes a driving coil for driving the diaphragm and a sensing coil for detecting movement of the diaphragm each constituting the coil. Winding portions of the driving coil and the sensing coil of the moveable unit face a protruding side surface that is a side surface of the top plate portion on a side where the protrusion portion is formed. The display method displays information that indicates a vibration transfer characteristic associated with the audio device and measured according to a detection signal generated by the sensing coil.

The display method described above can present to the user information regarding the vibration transfer characteristic measured according to the detection signal generated by the sensing coil included in the audio device of an embodiment.

### BRIEF DESCRIPTION OF DRAWINGS

FIG. 1 is a block diagram illustrating a configuration example of an audio device according to a first embodiment of the present technology.

FIG. 2 is a diagram illustrating an example of a compliance characteristic of a diaphragm.

FIG. 3 is a diagram illustrating an example of a waveform distortion.

FIG. 4 is a schematic vertical cross-sectional diagram of a speaker unit included in the audio device according to the embodiment.

FIG. 5 is a schematic perspective diagram illustrating an external appearance of a movable unit included in the speaker unit.

FIG. 6 is a diagram schematically illustrating a vertical cross-sectional structure of winding portions of a driving coil and a sensing coil included in the movable unit.

FIG. 7 is an explanatory diagram of a configuration example of an internal magnetic-type magnetic circuit unit.

FIG. 8 is an explanatory diagram of a configuration example of an internal/external magnetic-type magnetic circuit unit.

FIG. 9 is an explanatory diagram of a magnetic flux density distribution for the sensing coil.

FIG. 10 is a diagram illustrating a simulation result of a magnetic flux density distribution obtained in a case where a configuration of PTL 1 is adopted.

FIG. 11 is a diagram illustrating a simulation result of a magnetic flux density distribution obtained by the audio device according to the embodiment.

FIG. 12 is a diagram illustrating variation examples of a shape of a protrusion portion.

FIG. 13 is an explanatory diagram of a bobbinless structure.

FIG. 14 is a block diagram for explaining a configuration example for achieving a distortion correction method according to the embodiment.

FIG. 15 is a diagram illustrating a transfer function model of the configuration illustrated in FIG. 14.

FIG. 16 is a diagram illustrating a configuration example of an electric circuit unit which performs a process in which an inductive characteristic from the driving coil to the sensing coil is taken into consideration.

FIG. 17 is a diagram illustrating a configuration example of an audio device configured to compensate for a vibration transfer characteristic change over time and an individual variation.

FIG. 18 is a diagram for explaining a configuration example of an audio reproduction system according to a second embodiment.

FIG. 19 is a diagram illustrating an example of a GUI according to the second embodiment.

### DESCRIPTION OF EMBODIMENTS

Embodiments according to the present technology will hereinafter be described in the following order with reference to the accompanying drawings.
<1. First Embodiment>
(1-1. Configuration of audio device)
(1-2. Distortion correction method of embodiment)
(1-3. Modification of distortion correction process)
<2. Second Embodiment>
<3. Modifications>
<4. Summary of Embodiments>
<5. Present Technology>

### 1. First Embodiment

### (1-1. Configuration of Audio Device)

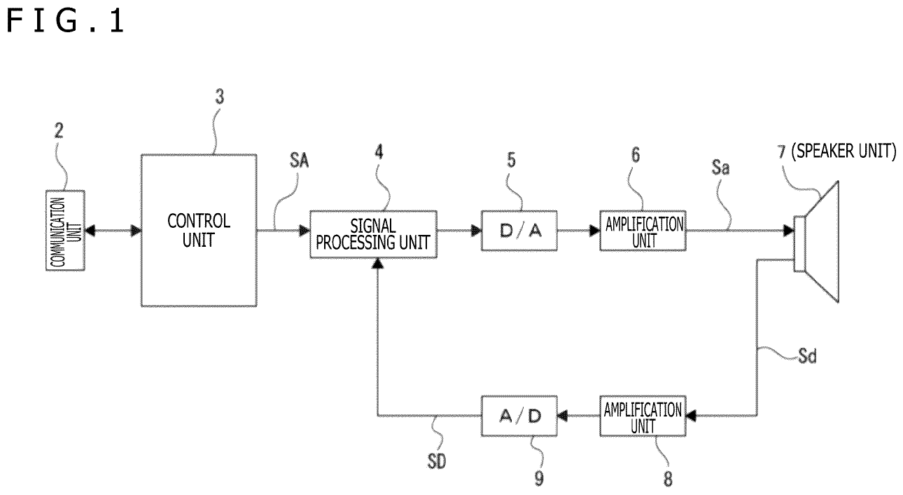

FIG. 1 is a block diagram illustrating a configuration example of an audio device 1 according to a first embodiment of the present technology.

The audio device 1 constitutes a “movable coil-type” audio device. The movable coil-type audio device refers to an audio device which includes a diaphragm, a movable unit having a coil and connecting with the diaphragm, and a magnetic circuit unit having a magnet and a yoke and generating magnetic force acting on the coil. Discussed in the present embodiment by way of example will be an audio device constituting a speaker device, such as an earphone and a headphone, as the audio device 1 of the movable coil-type noted above.

As illustrated in the figure, the audio device 1 includes a communication unit 2, a control unit 3, a signal processing unit 4, a D/A (Digital to Analog) converter 5, an amplification unit 6, a speaker unit 7, an amplification unit 8, and an A/D (Analog to Digital) converter 9.

For example, the control unit 3 includes a microcomputer which has a CPU (Central Processing Unit), a ROM (Read Only Memory), a RAM (Random Access Memory), and others. This CPU executes a process under a program stored in the ROM to implement overall control of the audio device 1 and various arithmetic processes.

For example, the control unit 3 receives audio signals SA in a form of digital signals from an external device via the communication unit 2, and outputs the received audio signals SA to the signal processing unit 4 provided in a subsequent stage. The communication unit 2 preforms device-to-device communication with the external device and communication via a network such as the Internet wirelessly or by wire.

It is assumed here that the audio signals SA received from the external device in the present embodiment are audio signals in multiple channels, such as stereo audio signals. While FIG. 1 illustrates only a configuration of one channel as an audio signal reproduction system including the speaker unit 7 as a typical example, this reproduction system is provided for each of multiple channels in an actual situation. For example, for a configuration handling stereo reproduction, two speaker units 7 are provided in correspondence with an L (left) channel and a R (right) channel. In addition, for a configuration handling multi-channel reproduction using three or more channels, three or more speaker units 7 are provided.

Note that a configuration including only one speaker unit 7 may be applied to the audio device 1 as a configuration handling monaural audio reproduction.

For example, the signal processing unit 4 constitutes a signal processing device such as a DSP (Digital Signal Processor), and performs various types of signal processing for the audio signals SA. For example, the signal processing unit 4 performs an equalizing process for adjusting frequency characteristics of the audio signals SA. Moreover, the signal processing unit 4 of the present embodiment particularly performs signal processing for distortion correction for the audio signals SA according to sensing signals obtained by a sensing coil 14 included in the speaker unit 7 and will be described below (sensing signals associated with movement of the diaphragm). This process corresponds to MFB (Motional Feed-Back) control described above.

Note that a method for the distortion correction of the present embodiment will be described again below.

Distortion to be corrected by MFB control will be touched upon here for confirmation.

The distortion to be corrected is distortion produced by mechanical characteristics of the diaphragm.

There exist various types of distortion considered as this distortion. For example, this distortion includes distortion produced by collapse of front-rear symmetry of vibration of the diaphragm and distortion produced by a Doppler effect which occurs during high-range reproduction in a case of reproduction of broadband signals ranging from a low range to a high-range.

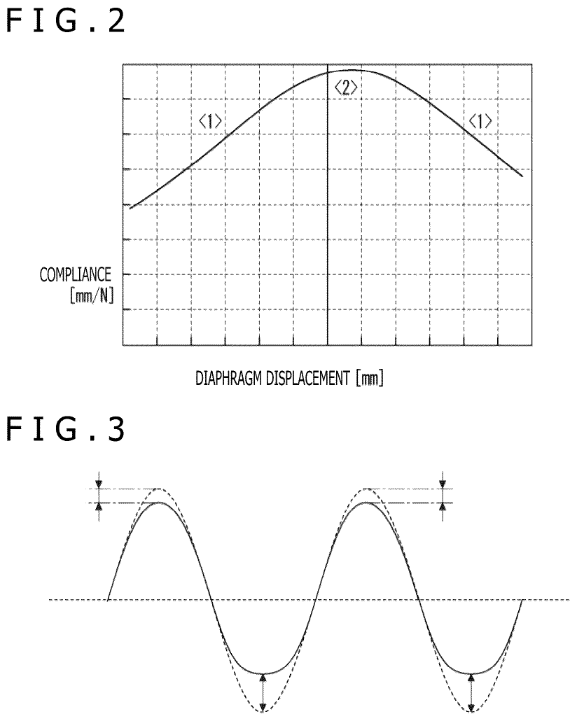

For example, mechanical distortion is produced by a compliance characteristic illustrated in FIG. 2, and causes separation between an ideal waveform (dotted line) and a reproduction waveform (solid line) as illustrated in FIG. 3.

Description will be made with reference to FIG. 1 again.

The audio signals SA processed by the signal processing unit 4 are converted into analog signals by the D/A converter 5, and amplified by the amplification unit 6. Thereafter, the amplified signals are supplied to the speaker unit 7 as audio signals Sa.

As will be described below, the speaker unit 7 includes a driving coil 13 for driving the diaphragm (diaphragm 10). The audio signals Sa are input to the speaker unit 7 as driving signals for the driving coil 13, and the driving coil 13 is driven according to the audio signals Sa. In this manner, the diaphragm 10 vibrates according to the audio signals Sa, and achieves audio reproduction corresponding to the audio signals Sa. This reproduction can hence be expressed as conversion of the audio signals Sa as electric signals into sound (vibration of air).

As will be described below, the speaker unit 7 further includes the sensing coil 14 provided in a movable unit connecting with the diaphragm 10. Sensing signals Sd associated with movement of the diaphragm 10 are obtained from the sensing coil 14.

As illustrated in the figure, the sensing signals Sd are amplified by the amplification unit 8, then converted into sensing signals SD in the form of digital signals by the A/D converter 9, and input to the signal processing unit 4. In other words, signals indicating movement of the diaphragm 10 are fed back to the signal processing unit 4.

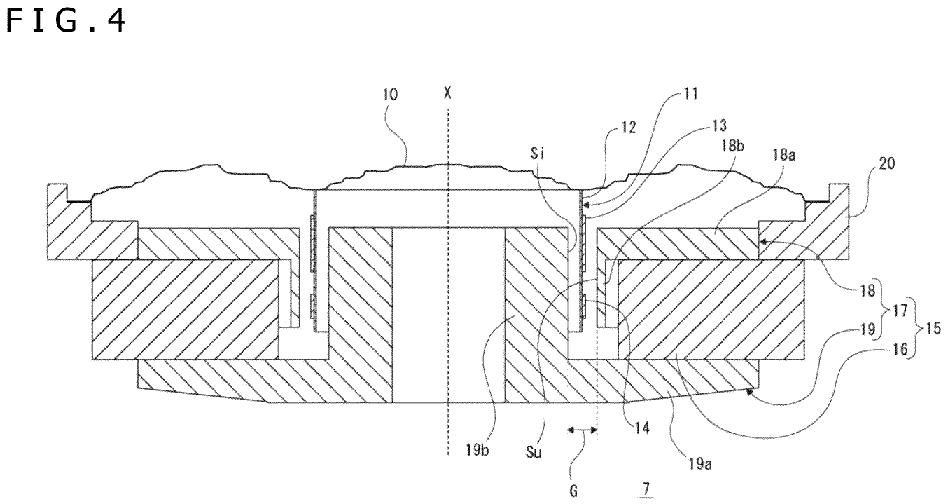

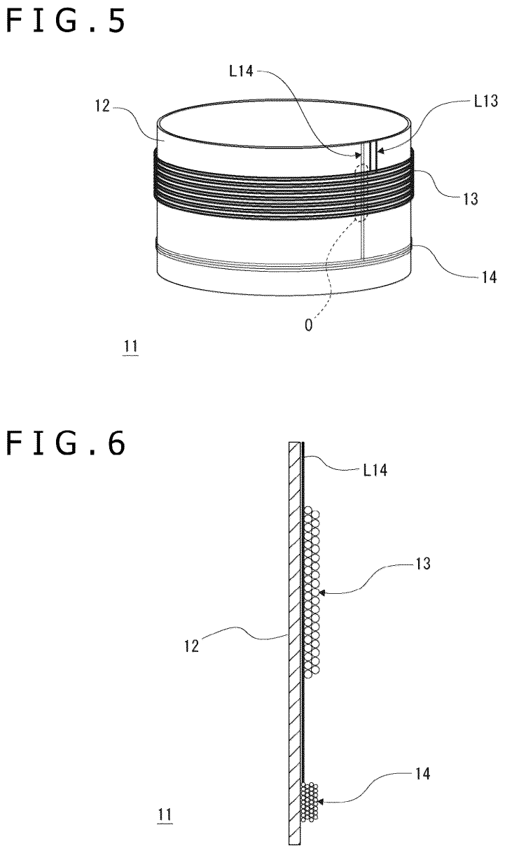

FIG. 4 is a schematic vertical cross-sectional diagram of the speaker unit 7, while FIG. 5 is a schematic perspective diagram illustrating an external appearance of a movable unit 11 included in the speaker unit 7.

Note that FIG. 4 particularly illustrates only constituent elements that are included in a portion associated with the embodiment and that are extracted from constituent elements of the speaker unit 7.

The speaker unit 7 includes the diaphragm 10, the movable unit 11 including coils and connecting with the diaphragm 10, and a magnetic circuit unit 15 including a magnet 16 and a yoke 17 and generating magnetic force acting on the coils (see FIG. 4). A vertical dotted line indicated by “X” in the figure represents a center axis of the speaker unit 7.

The magnetic circuit unit 15 included in the speaker unit 7 of the present embodiment is an external magnetic-type magnetic circuit which has the magnet 16 disposed on the outer circumferential side of the coils of the movable unit 11.

Note herein that directions in the present description are defined in the following manner to explain a positional relation between the respective constituent elements of the speaker unit 7. Specifically, a movable direction of the movable unit 11 corresponds to a vertical direction (up-down direction), while a direction where the diaphragm 10 is positioned as viewed from the coils of the movable unit 11 corresponds to an upward direction.

According to the present embodiment, the diaphragm 10 has a substantially circular external shape in a top view, and an outer circumferential portion of the diaphragm 10 is supported by a support portion 20 including a non-magnetic material. The diaphragm 10 according to the present embodiment is configured such that a portion on the inner circumferential side of a portion supported by the support portion 20 is connected with the movable unit 11.

The movable unit 11 is formed by winding the driving coil 13 and the sensing coil 14 around an outer circumferential surface of a bobbin 12 having a substantially cylindrical shape (see FIGS. 4 and 5). According to the present embodiment, the driving coil 13 and the sensing coil 14 are wound with a clearance left between each other in the vertical direction. According to the present embodiment, the driving coil 13 is wound above the sensing coil 14 as illustrated in the figure.

Moreover, according to the present embodiment, the driving coil 13 and the sensing coil 14 are wound in opposite directions. This point will be detailed again later.

The movable unit 11 is configured such that lead wires L13 from a winding start and a winding end of the driving coil 13 and lead wires L14 from a winding start and a winding end of the sensing coil 14 are wired in the vertical direction on an outer circumferential surface of the bobbin 12 (see FIG. 5). According to the present embodiment, the lead wires L13 and L14 are wired upward from the respective coils.

While not illustrated in the figure, the lead wires L13 are connected with the amplification unit 6 illustrated in FIG. 1. This configuration enables the driving coil 13 to be driven according to the audio signals Sa as driving signals as described above.

Moreover, the lead wires L14 are connected with the amplification unit 8 illustrated in FIG. 1. This configuration enables the sensing signals SD to be fed back to the signal processing unit 4 as described above.

According to the present embodiment, the lead wires L14 are wired on the inner side of the driving coil 13 (see FIG. 5). This configuration is formed in the following manner in the present embodiment. The sensing coil 14 is first wound around the bobbin 12, and the lead wires L14 of the sensing coil 14 are wired upward. Thereafter, the driving coil 13 is wound on the outer side of the lead wires L14.

Note here that each of the portions of the driving coil 13 on the inner side of which the lead wires L14 are provided as described above protrudes toward the outer circumferential side from the other portion of the driving coil 13. Each of these portions will hereinafter be referred to as an “outwardly protruding portion O.”

According to the present embodiment, each of wires that include the lead wires L14 and that are provided for the sensing coil 14 has a smaller thickness than each of wires provided for the driving coil 13 (including wires of the lead wires L13). Specifically, according to the present embodiment, a wire diameter of the latter wires is smaller than a wire diameter of the former wires.

Note that advantages of this reduction in the thickness of the wires of the sensing coil 14 will be described again later.

According to the present embodiment, each of the driving coil 13 and the sensing coil 14 includes a wire called a voice coil wire. For example, a copper wire, a copper-clad aluminum wire, or the like is available for this wire. It is preferable that the wires of the driving coil 13 have a large diameter to supply large current for driving the diaphragm 10. Meanwhile, the wires of the sensing coil 14 are configured to detect a voltage value of induced electromotive force generated according to movement of the diaphragm 10. In this case, no current is required to be supplied to the sensing coil 14. In addition, a larger number of times of winding raises induced electromotive force, and increases sensitivity of vibration sensing. Accordingly, the wires of the sensing coil 14 may be wires having higher conductor resistance (i.e., a small wire diameter).

FIG. 6 schematically illustrates a vertical cross-sectional structure of winding portions of the driving coil 13 and the sensing coil 14 included in the movable unit 11.

As illustrated in FIG. 6 by way of example, the driving coil 13 may be wound to have two layers, and the sensing coil 14 may be wound to have four layers, for example. Note that the numbers of the winding layers are not limited to these numbers in the present embodiment.

As illustrated in FIG. 4, the movable unit 11 is configured such that an upper end portion of the bobbin 12 is connected with the diaphragm 10. This configuration enables the diaphragm 10 to vibrate in association with movement of the movable unit 11 in the vertical direction.

The yoke 17 included in the magnetic circuit unit 15 includes a top plate portion 18 which is located above the magnet 16 and has a top surface portion 18a extending in a direction (horizontal direction) substantially perpendicular to the movable direction (vertical direction) of the movable unit 11; and a pole piece portion 19d which is located below the magnet 16 and has a bottom portion 19a formed such that the magnet 16 is held between the bottom portion 19a and the foregoing top surface portion 18a.

The top plate portion 18 has a protrusion portion 18b which has an annular shape in a top view and protrudes downward from an inner edge of the top surface portion 18a. The protrusion portion 18b has an annular shape in a bottom view.

As illustrated in the figure, the magnet 16 is located on the outer circumferential side of the protrusion portion 18b and held between the top surface portion 18a and the bottom portion 19a.

Note here that a side surface included in the top plate portion 18 and located on the side where the protrusion portion 18b is formed (an inner side surface in the present embodiment) will hereinafter be referred to as a “protruding side surface Su.”

The pole piece portion 19 has a wall portion 19b which has an annular shape in a bottom view and protrudes upward from an inner edge of the bottom portion 19a. The wall portion 19b has an annular shape in a top view.

The wall portion 19b is located on an inner side of the protrusion portion 18b of the top plate portion 18. A side surface included in the wall portion 19b and facing the protrusion portion 18b will be referred to as a facing surface Si. A gap G is provided as a clearance between the facing surface Si and the protruding side surface Su of the top plate portion 18.

According to the present embodiment, a vertical cross-sectional width (a horizontal length in a vertical cross-sectional view) of the protrusion portion 18b of the top plate portion 18 is smaller than a vertical cross-sectional width of the wall portion 19b.

As illustrated in the figure, the movable unit 11 is disposed such that the winding portions of the driving coil 13 and the sensing coil 14 are positioned within the gap G. In other words, the winding portions of the driving coil 13 and the sensing coil 14 of the movable unit 11 face the protruding side surface Su of the top plate portion 18.

The magnetic circuit unit 15 adopted in the present embodiment is an external magnetic-type unit. Accordingly, the driving coil 13 and the sensing coil 14 face the protruding side surface Su located on the outer side as illustrated in the figure.

FIG. 4 illustrates a state where the movable unit 11 is located at a neutral position. In this neutral state, the position of the driving coil 13 in the vertical direction is close to the top surface portion 18a, while the position of the sensing coil 14 in the vertical direction is close to a distal end portion (lower end portion) of the protrusion portion 18b according to the present embodiment as illustrated in the figure.

As described above, the winding portions of the driving coil 13 and the sensing coil 14 of the movable unit 11 are located within the gap G. This configuration enables the magnetic circuit unit 15 to apply magnetic force generated near the gap G to each of the driving coil 13 and the sensing coil 14. Accordingly, vertical displacement of the movable unit 11 is achieved with supply of driving signals (supply of driving current) to the driving coil 13, and consequently vibrates the diaphragm 10. Moreover, with displacement of the movable unit 11, an electric signal corresponding to an amount and a direction of this displacement can be generated by the sensing coil 14. In this manner, the sensing signal Sd indicating movement of the diaphragm 10 can be acquired.

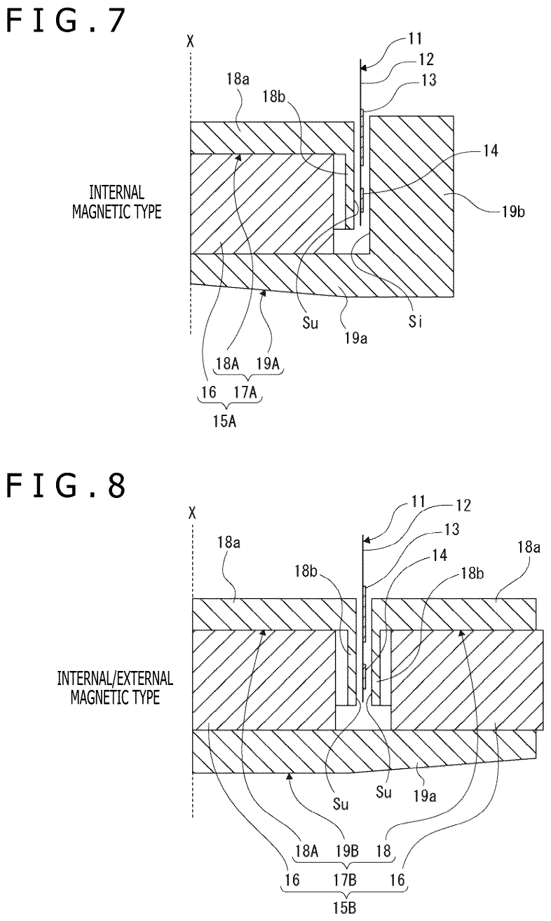

While the example of the external magnetic-type circuit unit 15 adopted as the magnetic circuit unit for generating magnetic force acting on the coils has been discussed above, the speaker unit 7 according to the embodiment may include an internal magnetic-type magnetic circuit unit 15A illustrated in FIG. 7 by way of example, or an internal/external magnetic-type magnetic circuit unit 15B illustrated in FIG. 8 by way of example.

Note that each of the magnetic circuit units 15A and 15B has a left-right symmetric configuration with respect to a center axis X. Accordingly, only a configuration on the right side of the center axis X is extracted and illustrated in each of FIGS. 7 and 8.

Note that parts similar to corresponding parts already discussed above will be given identical reference signs, and will not repeatedly be explained hereinafter.

The internal magnetic-type magnetic circuit unit 15A illustrated in FIG. 7 includes a yoke 17A disposed such that the positional relation between the magnet 16 and the components of the protrusion portion 18b and the wall portion 19b in the inside-outside direction is opposite to the corresponding positional relation illustrated in FIG. 4. Specifically, the yoke 17A includes a top plate portion 18A and a pole piece portion 19A. As illustrated in the figure, the top plate portion 18A has the top surface portion 18a having a substantially circular shape in a top view and the protrusion portion 18b protruding downward from an outer edge of the top surface portion 18a. In this case, the protruding side surface Su, which is a side surface included in the top plate portion 18A and located on the side where the protrusion portion 18b is formed, faces outward.

Meanwhile, the pole piece portion 19A has the bottom portion 19a having a substantially circular shape in a bottom view and the wall portion 19b protruding upward from an outer edge of the bottom portion 19a.

As illustrated in the figure, the magnet 16 in this case is located on the inner side of the protrusion portion 18b and held between the bottom portion 19a and the top surface portion 18a of the top plate portion 18A.

The facing surface Si of the wall portion 19b included in the pole piece portion 19A is a surface facing inward. The winding portions of the driving coil 13 and the sensing coil 14 of the movable unit 11 are located within the gap G formed between the facing surface Si and the protruding side surface Su of the top plate portion 18A. In other words, these winding portions face the protruding side surface Su.

The internal/external magnetic-type magnetic circuit unit 15B illustrated in FIG. 8 includes a yoke 17B which has the top plate portion 18A having a protrusion portion 18b protruding downward from the outer edge of the top surface portion 18a, the top plate portion 18 that is located on the outer circumferential side of the top plate portion 18A and that has the protrusion portion 18b protruding downward from the inner edge of the top surface portion 18a, and a pole piece portion 19B that has the bottom portion 19a disc-shaped and that is located below the top plate portions 18A and 18. This configuration includes the two magnets 16, i.e., the magnet 16 (substantially disc-shaped) located on the inner side of the protrusion portion 18b of the top plate portion 18A, and the magnet 16 (annular) located on the outer side of the protrusion portion 18b of the top plate portion 18. As illustrated in the figure, the bottom portion 19a of the pole piece portion 19B extends in the horizontal direction (radial direction) from the center axis X to a vicinity of the outer edge of the magnet 16 disposed on the outer side. The magnet 16 located on the inner side is held between the bottom portion 19a and the top surface portion 18a of the top plate portion 18A, while the magnet 16 located on the outer side is held between the bottom portion 19a and the top surface portion 18a of the top plate portion 18.

In this case, the protruding side surface Su, which is a side surface where the protrusion portion 18b of the top plate portion 18A is formed, faces outward, while the protruding side surface Su, which is a side surface where the protrusion portion 18b of the top plate portion 18 is formed, faces inward. The winding portions of the driving coil 13 and the sensing coil 14 of the movable unit 11 are located within the gap G formed between the respective protruding side surfaces Su. In other words, these winding portions face the protruding side surfaces Su.

While not illustrated in the figure, a sigma-type magnetic circuit unit which has two magnets alternately arranged between three plates (with polarities oppositely arranged) may be adopted as the magnetic circuit unit, for example. Hence, the magnetic circuit unit is not limited to the external magnetic-type, the internal magnetic-type, and the internal/external magnetic-type presented above by way of example.

As described above, the speaker unit 7 of the audio device 1 according to the present embodiment is configured such that the top plate portion 18 (or 18A) includes the protrusion portion 18b, and that the winding portions of the driving coil 13 and the sensing coil 14 of the movable unit 11 face the protruding side surface Su of the top plate portion 18.

According to this configuration, the magnetic circuits for the first and second coils can be formed using a common magnet and a common yoke. In other words, this configuration can eliminate the necessity of providing individual magnets and yokes for the respective coils as required in PTL 1 and PTL 2 noted above.

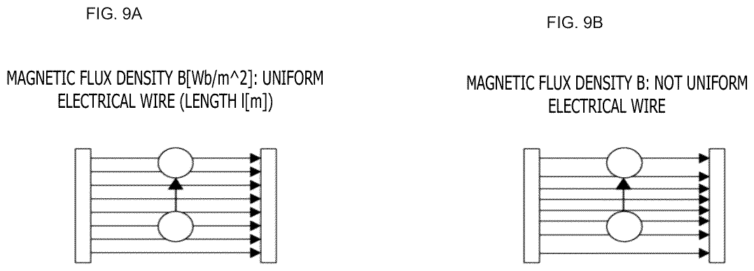

This point will hereinafter be explained with reference to FIGS. 9 through 11.

First, the following points should be understood as the basic idea for this discussion. It is preferable that magnetic force acting on the driving coil 13 have higher magnetic flux density in view of improvement of driving efficiency. Meanwhile, a uniform magnetic flux density distribution of the sensing coil 14 in the vertical direction is ideal for accurate detection of a displacement amount of the movable unit 11.

FIG. 9 schematically illustrates a state where a magnetic flux density distribution in the vertical direction is uniform (FIG. 9A) and a state where this distribution is not uniform (FIG. 9B). In a case where the magnetic flux density distribution in the vertical direction is not uniform as illustrated in FIG. 9B, a change amount of magnetic force produced when the sensing coil 14 moves by a fixed quantity varies according to a vertical position of the sensing coil 14. In other words, a change amount of a value of a sensing signal produced when the sensing coil 14 moves by the fixed quantity varies according to the vertical position of the sensing coil 14.

Meanwhile, if the magnetic flux density distribution in the vertical direction is uniform as illustrated in FIG. 9A, the change amount of the magnetic force produced when the sensing coil 14 moves by the fixed quantity is fixed regardless of the vertical position of the sensing coil 14. Accordingly, a displacement amount of the movable unit 11 is accurately detectable.

According to the inventions described in PTL 1 and PTL 2, the magnet and the yoke are provided for each of the coils to provide magnetic flux density distributions appropriate for purposes of the coils for the respective regions containing the driving coil and the sensing coil.

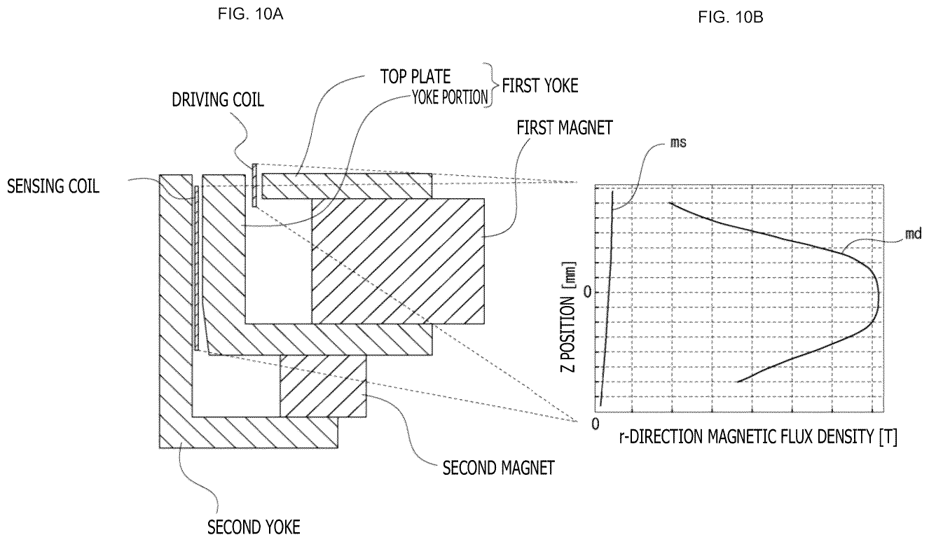

FIG. 10 illustrates a simulation result of a magnetic flux density distribution obtained in a case where the configuration of PTL 1 is adopted.

PTL 1 is configured such that a magnetic flux density distribution for a driving coil indicated as “md” in FIG. 10B is obtained by use of a first magnetic circuit including a first magnet and a first yoke (including a top plate) as illustrated in FIG. 10A. In addition, PTL 1 is configured such that a magnetic flux density distribution for a sensing coil indicated as “ms” in FIG. 10B is obtained by use of a second magnetic circuit including a second magnet and a second yoke as illustrated in FIG. 10A. Note that each of Z positions (vertical positions) indicated on a vertical axis in FIG. 10B represents a position of the driving coil or the sensing coil on an assumption that each of vertical center positions of the coils at the time of neutral positions is “0.” Moreover, an r-direction magnetic flux density distribution on a horizontal axis represents vertical density of horizontal (radial) magnetic flux.

As illustrated in the figure, the r-direction magnetic flux density distribution md for the driving coil obtains a mountain-shaped characteristic having a peak near the Z position of 0. Meanwhile, the r-direction magnetic flux density distribution ms for the sensing coil obtains a characteristic exhibiting substantially uniform magnetic flux regardless of the vertical position (i.e., substantially flat characteristic). In this case, a peak value of the r-direction magnetic flux distribution md is made larger than the maximum value of the r-direction magnetic flux distribution ms so as to increase driving efficiency of the movable unit.

According to the present embodiment, as illustrated in FIGS. 4, 7, and 8, the top plate portion 18 (or 18A) includes the protrusion portion 18b. This configuration can provide magnetic flux density distributions appropriate for purposes of the coils for the respective regions containing the coils without forming the magnet and the yoke for each of the coils.

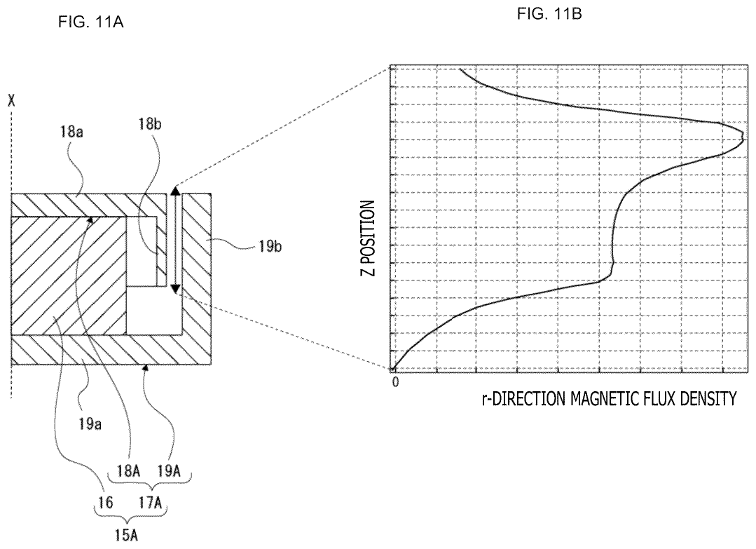

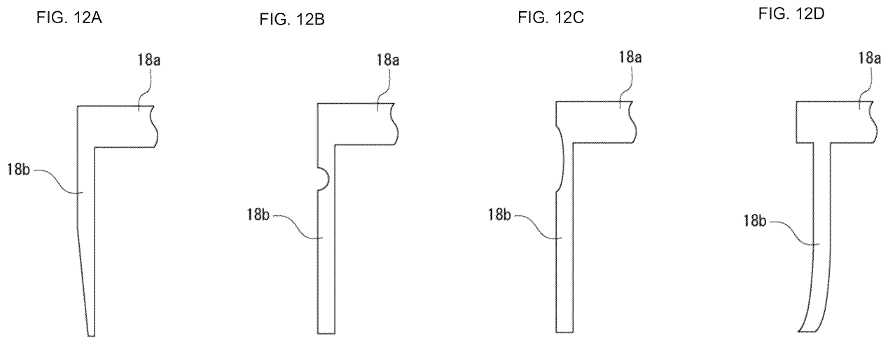

FIG. 11 illustrates a simulation result of a magnetic flux density distribution obtained in a case where the internal magnetic-type magnetic circuit unit 15A illustrated in FIG. 7 is used by way of example. In FIG. 11, FIG. 11B illustrates a distribution characteristic of r-direction magnetic flux density in a vertical range corresponding to the winding portions of the driving coil 13 and the sensing coil 14 as indicated by vertical two-way arrows in FIG. 11A.

As illustrated in the figure, the configuration including the protrusion portion 18b provides such a characteristic which has a peak of the r-direction magnetic flux density around the winding portion of the driving coil 13 and has a flat r-direction magnetic flux density distribution around the winding portion of the sensing coil 14.

Accordingly, the magnetic flux density distributions appropriate for the purposes of the coils can be produced in the respective regions containing the coils without providing the magnet and the yoke for each of the coils.

While not described with reference to the figure, it has been confirmed that similar magnetic flux density distributions are obtainable even in a case where the external magnetic-type magnetic circuit unit 15 and the internal/external magnetic-type magnetic circuit unit 15B are adopted.

Note here that the characteristic of the r-direction magnetic flux density distribution obtained by the magnetic circuit unit 15 (or 15A, 15B) is adjustable by controlling the shape, the length, or the like of the protrusion portion 18b.

FIG. 12 illustrates variation examples of the shape of the protrusion portion 18b. While the examples in FIG. 12 are variations of the external magnetic-type magnetic circuit unit 15, similar shape variations may be applied to the internal magnetic-type magnetic circuit unit 15A.

FIG. 12A illustrates an example of a tapered shape. As illustrated in the figure, the width of the protrusion portion 18b decreases in the downward direction.

Each of FIGS. 12B and 12C illustrates an example of a notched shape. The example illustrated in FIG. 12B is a notch formed at a part of the protrusion portion 18b and forming a protruding shape toward the outer circumference, while the example illustrated in FIG. 12C is a notch extending from an upper end portion of the protrusion portion 18b to a lower end portion of the top surface portion 18a and forming a protruding shape toward the outer circumference.

FIG. 12D illustrates an example of the protrusion portion 18b which has an inner circumferential surface offset in the horizontal direction (radial direction) from an inner circumferential surface of the top surface portion 18a. Specifically, the inner circumferential surface of the protrusion portion 18b is offset to the outer circumferential side from the inner circumferential surface of the top surface portion 18a. In addition, a lower end of the protrusion portion 18b is bended toward the inner circumference in this example.

Note here that the driving coil 13 and the sensing coil 14 are wound around the same bobbin 12 as described above. In this configuration, the driving coil 13 and the sensing coil 14 are supported by the same support body, and hence, a difference in movement is eliminated between the driving coil 13 and the sensing coil 14.

Accordingly, movement of the diaphragm 10 is more accurately detectable by the sensing coil 14.

Moreover, according to the example described above, the driving coil 13 and the sensing coil 14 are wound at positions away from each other in the vertical direction. This configuration reduces electromotive force generated in the sensing coil 14 in association with a flow of driving current in the driving coil 13.

Accordingly, movement of the diaphragm 10 is more accurately detectable by the sensing coil.

Further, separation between the driving coil 13 and the sensing coil 14 can prevent overlap between the driving coil 13 and the region having the magnetic flux density distribution characteristic for sensing in the magnetic circuit unit 15 (or 15A, 15B), or opposite overlap, i.e., overlap between the sensing coil 14 and the region having the magnetic flux density distribution characteristic for driving.

Accordingly, improvement of driving efficiency and driving performance of the diaphragm 10 and improvement of detection accuracy of the movement of the diaphragm 10 are both achievable.

In addition, as described above, the driving coil 13 and the sensing coil 14 are wound in opposite directions according to the present embodiment.

When the driving coil 13 and the sensing coil 14 are wound in opposite directions as in this configuration, electromotive force generated in the sensing coil 14 by movement of the movable unit 11 and electromotive force generated in the driving coil 13 by a flow of driving current have opposite polarities.

Accordingly, a variation width of voltage of the sensing signal generated by the sensing coil 14 at the time of movement of the movable unit 11 can be reduced.

Besides, as illustrated in FIGS. 5 and 6 referred to above, the driving coil 13 is wound on the outer side of the lead wires L14 of the sensing coil 14, and the wire thickness of the sensing coil 14 including the lead wires L14 is smaller than the wire thickness of the driving coil 13 according to the present embodiment.

This configuration can reduce the above-described protrusion amount of the outwardly protruding portion O of the driving coil 13.

In this case, a clearance width required between the driving coil 13 and the yoke can be reduced, and a magnetic gap of the driving coil 13 can be made smaller. Accordingly, driving efficiency of the diaphragm 10 can be raised.

Note that each of the driving coil 13 and the sensing coil 14 may have a bobbinless configuration. Specifically, the driving coil 13 and the sensing coil 14 may be wound as one body by use of a bobbinless winding method.

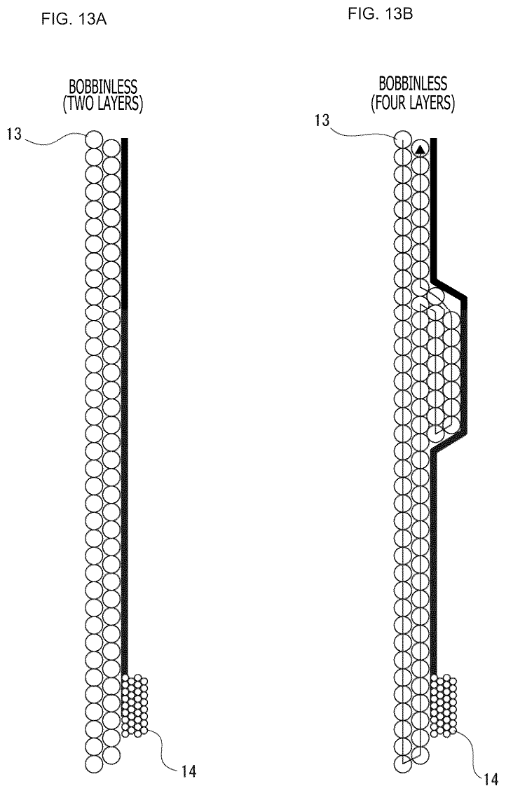

For example, some small speakers included in earphones or the like each have a self-fusing line to use a bobbinless voice coil. In this case, the driving coil 13 may adopt a two-layer structure as illustrated in FIG. 13A, or a four-layer structure as illustrated in FIG. 13B, for example. Note that even numbers of layers are formed to equalize the positions of the winding start and the winding end of the coil. However, the number of the layers in this case may be either an even number or an odd number.

According to the example of FIG. 13A, the sensing coil 14 having four layers are wound on the outer circumferential side of the driving coil 13 having two layers. According to the example of FIG. 13B, the driving coil 13 has four layers only in a partial region in the vertical direction and two layers in a remaining region, and the sensing coil 14 having four layers is wound on the outer circumferential side of the two-layer winding region of the driving coil 13 away from the four-layer region in the vertical direction. Note that the number of layers in a partial region in the vertical direction may be different from the number of layers in the other region as in the example of FIG. 13B. In this case, the number of layers in the partial region in the vertical direction and the number of layers in the other region may be an odd number and an even number, or an even number and an odd number, respectively.

The bobbinless structure adopted as above can reduce the size and the weight of the device by removal of the bobbin 12.

It is considered here that the driving coil 13 and the sensing coil 14 are supported by the same support body even in the bobbinless structure adopted as described above as in the case of the driving coil 13 and the sensing coil 14 being wound around the same bobbin 12.

### (1-2. Distortion Correction Method of Embodiment)

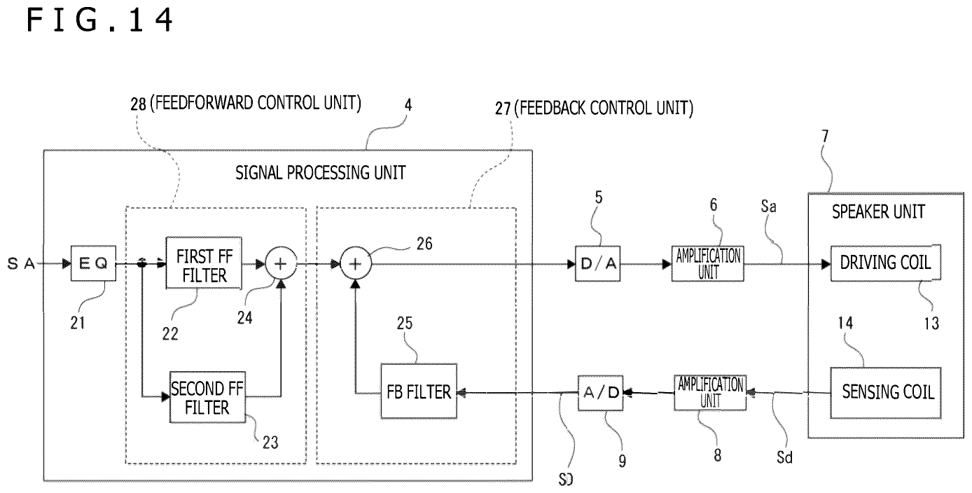

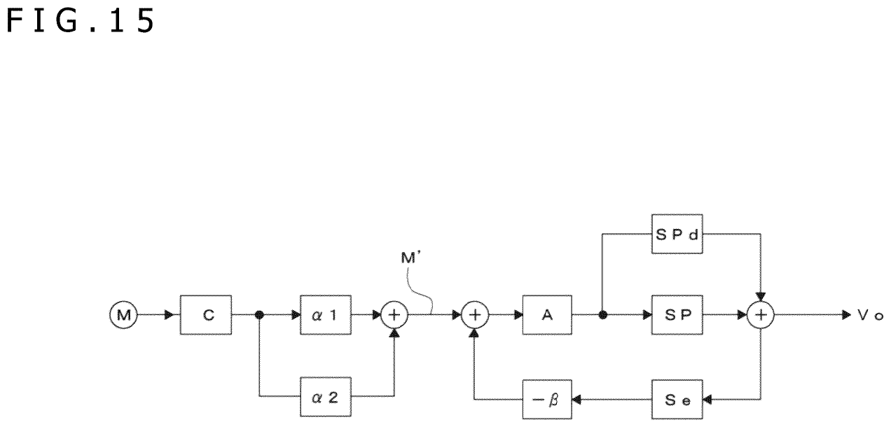

A distortion correction method according to the embodiment will next be described with reference to FIGS. 14 and 15.

The present embodiment adopts such a method which uses feedforward control in combination with feedback control corresponding to MFB control to achieve a distortion correction process based on the sensing signal Sd obtained by the sensing coil 14.

FIG. 14 is a block diagram for explaining a configuration example for achieving the distortion correction method according to the embodiment, and illustrates the D/A converter 5, the amplification unit 6, the speaker unit 7 (driving coil 13 and sensing coil 14), the amplification unit 8, and the A/D converter 9 illustrated in FIG. 1, together with an internal configuration example of the signal processing unit 4.

As illustrated in the figure, the signal processing unit 4 includes an equalizer 21, a first FF (Feed-Forward) filter 22, a second FF filter 23, an adder 24, an FB (Feed-Back) filter 25, and an adder 26.

Each of the equalizer 21, the first FF filter 22, the second FF filter 23, and the FB filter 25 constitutes a frequency filter which adjusts a frequency characteristic for input signals. For example, a digital filter such as an FIR (Finite Impulse Response) filter and an IIR (Infinite Impulse Response) filter is available.

The equalizer 21 performs sound quality adjustment filtering for the input audio signals SA.

The first FF filter 22, the second FF filter 23, and the adder 24 constitute a feedforward control unit 28. The first FF filter 22 and the second FF filter 23 perform, in the feedforward control, a filtering process for correcting a linear characteristic and a filtering process for correcting a non-linear characteristic, respectively. As illustrated in the figure, the feedforward control unit 28 causes the first FF filter 22 and the second FF filter 23 to filter the audio signals SA processed by the equalizer 21, and causes the adder 24 to add the respective filtered signals together.

The FB filter 25 and the adder 26 constitute a feedback control unit 27. The FB filter 25 receives the sensing signals SD output from the A/D converter 9, and performs filtering for distortion correction.

The adder 26 adds the sensing signals SD processed by the FB filter 25 to an output from the adder 24 of the feedforward control unit 28, and outputs the added signals to the D/A converter 5.

As described above, according to the present embodiment, the feedforward control unit 28 is provided in addition to the feedback control unit 27 performing feedback control corresponding to conventional MFB control. Accordingly, distortion not corrected by the feedback control unit 27 alone is correctable.

This point will further be explained with reference to FIG. 15.

FIG. 15 illustrates a transfer function model of the configuration illustrated in FIG. 14.

In the figure, “M” represents the audio signal SA, “C” represents a transfer characteristic (transfer function) of the equalizer 21, “α1” represents a transfer characteristic (linear correction) of the first FF filter 22, “α2” represents a transfer characteristic (non-linear correction) of the second FF filter 23, and “M′” represents an output signal of the feedforward control unit 28. In addition, “−β” represents a transfer characteristic of the FB filter 25, “A” represents a transfer characteristic of the amplification unit 6, “SP” and “SPd” represent a transfer characteristic of a linear component and a transfer characteristic of a non-linear component obtained by the speaker unit 7 (a transfer system from the driving coil 13 to the diaphragm 10), respectively, “Vo” represents vibration (reproduction sound) of the diaphragm 10, and “Se” represents a transfer characteristic of a transfer system from the diaphragm 10 to the amplification unit 8 of the sensing coil 14.

MFB control senses the final vibration Vo of the diaphragm 10 affected by the amplification characteristic A and the speaker characteristics SP (linear) and SPd (non-linear), and feeds back the vibration Vo to an input of the amplifier to reduce distortion. A feedback amount is determined by the sensing characteristic Se and a coefficient β of feedback control. Feedforward control performed in a stage before MFB control is control for cancelling distortion not reducible by MFB control alone. Accordingly, α2 for non-linear correction of feedforward control is a value to be calculated in consideration of a distortion reduction effect of MFB control.

Based on FIG. 15, Vo is expressed as following [equation 1] with use of M′.

$$[ Math . 1 ]$$

$$Vo = A \cdot ( SP + SPd ) ( {M}^{′} - Vo \cdot Se \cdot β ) \qquad [ Equation 1 ]$$

In this case, by substituting [equation 2] for [equation 1] and rearranging the resultant equation,

$$[ Math . 2 ]$$

$${M}^{′} = M \cdot C ( α1 + α2 ) \qquad [ Equation 2 ]$$

Vo is expressed as following [equation 3] with use of M.

$$[ Math . 3 ]$$

$$Vo = \frac{A \cdot ( SP + SPd )}{1 + A \cdot ( SP + SPd ) \cdot Se \cdot β} C \cdot ( α1 + α2 ) \cdot M \qquad [ Equation 3 ]$$

Feedforward control is performed for the purpose of cancelling the remaining non-linear component after MFB control, i.e., cancelling SPd contained in [equation 3]. Accordingly, [equation 4] is obtained by erasing SPd and α2 from [equation 3] to calculate α2 meeting [equation 4].

$$[ Math . 4 ]$$

$$Vo = \frac{A \cdot SP}{1 + A \cdot SP \cdot Se \cdot β} C \cdot α1 \cdot M \qquad [ Equation 4 ]$$

Subsequently, [equation 5] is obtained by substituting [equation 4] for [equation 3] and rearranging the resultant equation.

$$[ Math . 5 ]$$

$$α2 = [ \frac{SP \cdot \{ 1 + A \cdot ( SP + SPd ) \cdot Se \cdot β \}}{( SP + SPd ) \cdot ( 1 + A \cdot SP \cdot Se \cdot β )} - 1 ] \cdot α 1 \qquad [ Equation 5 ]$$

Feedforward control is such control which measures, predicts, and inputs a characteristic of a speaker, and hence contains an error component. Accordingly, [equation 5] is expressed as [equation 6] with use of an error e.

$$[ Math . 6 ]$$

$$α2 = [ \frac{SP \cdot \{ 1 + A \cdot ( SP + SPd ) \cdot Se \cdot β \}}{( SP + SPd ) \cdot ( 1 + A \cdot SP \cdot Se \cdot β )} - 1 ] \cdot α 1 + e \qquad [ Equation 6 ]$$

Subsequently, [equation 7] is obtained by substituting [equation 6] for [equation 3] and rearranging the resultant equation.

$$[ Math . 7 ]$$

$$Vo = \frac{A \cdot C \cdot SP}{( 1 + A \cdot SP \cdot Se \cdot β )} \cdot α1 \cdot C \cdot M + \frac{A \cdot ( SP + SPd )}{1 + A \cdot ( SP + SPd ) \cdot Se \cdot β} C \cdot e \cdot M \qquad [ Equation 7 ]$$

The value α1 for correcting linearity of feedforward is defined here as “α1=1+A·SP·Se·β” to erase a denominator. In this case, [equation 4] is rearranged into [equation 8].

$$[ Math . 8 ]$$

$$Vo = A \cdot SP \cdot {C}^{2} \cdot M + \frac{A \cdot ( SP + SPd )}{1 + A \cdot ( SP + SPd ) \cdot Se \cdot β} C \cdot e \cdot M \qquad [ Equation 8 ]$$

Assuming here that β of feedback control is sufficiently large, [expression 9] holds.

$$[ Math . 9 ]$$

$$Vo \text{?} A \cdot SP \cdot {C}^{2} \cdot M + \frac{1}{Se \cdot β} C \cdot e \cdot M \qquad [ Equation 9 ]$$

As apparent from this expression, a value of {1/(Se·β)}C·e·M approaches 0 as β becomes larger. Accordingly, the error e of feedforward control can be minimized by feedback control, and hence, distortion can considerably be reduced by combining the two control methods.

### (1-3. Modification of Distortion Correction Process)

Note herein that mutual induction caused by current flowing in the driving coil 13 generates electromotive force in the sensing coil 14 as described above. Specifically, magnetic coupling occurs between the driving coil 13 and the sensing coil 14 as noted above. In association with this phenomenon, the sensing coil 14 outputs signals combining both electromotive force generated by movement of the diaphragm 10 and electromotive force generated by magnetic coupling. These signals constitute error components for feedback control.

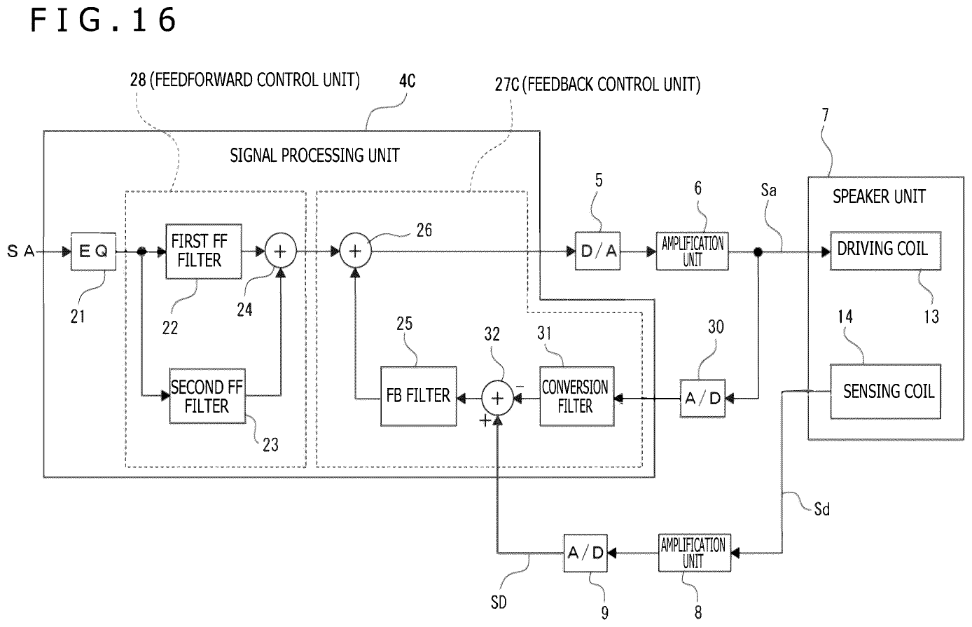

Accordingly, as illustrated in FIG. 16, such a configuration may be adopted which includes a signal processing unit 4C including a feedback control unit 27C instead of the feedback control unit 27.

The feedback control unit 27C includes a conversion filter 31 and a subtractor 32 in addition to the FB filter 25 and the adder 26. As illustrated in the figure, the audio signal Sa amplified by the amplification unit 6 is input to the conversion filter 31 after A/D conversion by the A/D converter 30. The signal filtered by the conversion filter 31 is subtracted from the sensing signal SD by the subtractor 32, and the sensing signal SD obtained after subtraction is input to the FB filter 25.

According to the present embodiment, the sensing coil 14 and the driving coil 13 are fixed to the same bobbin 12, or unified into one body in the bobbinless structure. In this case, the relative positions of these coils do not change. The magnetic coupling characteristic is thus a static characteristic depending on signals of the driving coil 13. Accordingly, an inductive characteristic from the driving coil 13 to the sensing coil 14 is measured in advance in a separated state from the magnetic circuit. Thereafter, the measured inductive characteristic is reproduced by the conversion filter 31. In this manner, an effect by the magnetic coupling from the driving coil 13 to the sensing coil 14 is appropriately eliminated, and therefore movement of the diaphragm 10 is more accurately detectable.

While described above has been the configuration which causes the conversion filter 31 to reproduce the inductive characteristic obtained in advance and subtracts output of the conversion filter 31 from the sensing signal SD, there can also be adopted such a configuration which causes the conversion filter 31 to reproduce an inverse characteristic of the inductive characteristic obtained in advance and adds output of the conversion filter 31 to the sensing signal SD.

Note here that a configuration including the sensing coil 14, such as the audio device 1 of the embodiment, is capable of identifying a relation between voltage applied to the driving coil 13 and a position of the diaphragm 10 corresponding to this voltage, according to the sensing signal SD. In other words, this configuration is capable of obtaining a transfer characteristic (vibration transfer characteristic) of the vibration transfer system from the driving coil 13 to the diaphragm 10. For example, this vibration transfer characteristic may be obtained as the compliance characteristic illustrated in FIG. 2 by way of example.

If the vibration transfer characteristic is actually measurable, a characteristic change over time from a reference time such as a factory shipment time, an individual characteristic variation, and the like are recognizable from the vibration transfer characteristic. Accordingly, described here will be a configuration of an audio device 1D which is a modification capable of compensating for a vibration transfer characteristic change over time and an individual variation.

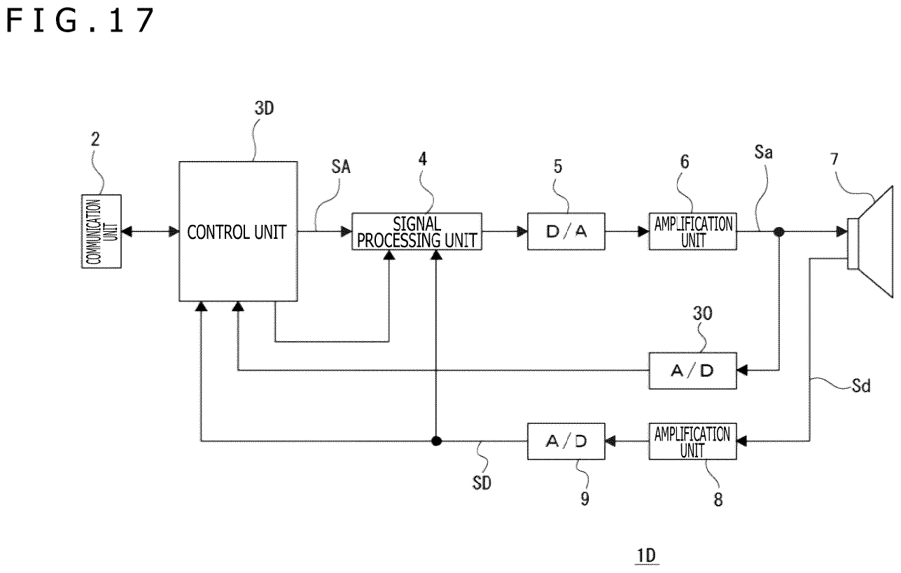

FIG. 17 is a block diagram illustrating a configuration example of the audio device 1D.

The audio device 1D is different from the audio device 1 illustrated in FIG. 1 in that a control unit 3D is provided instead of the control unit 3 and that an A/D converter 30 which achieves A/D conversion of the audio signal Sa amplified by the amplification unit 6 is added. As illustrated in the figure, the audio signal Sa that is A/D converted by the A/D converter 30 is input to the control unit 3D. Moreover, the sensing signal SD obtained by the A/D converter 9 is input to the control unit 3D.

The control unit 3D calculates a vibration transfer characteristic of the vibration transfer system from the driving coil 13 to the diaphragm 10, according to the sound signal Sa and the sensing signal SD that are obtained after A/D conversion. For example, the vibration transfer characteristic in this case may be calculated in response to an operation by a user, according to the sound signal Sa and the sensing signal SD obtained at the time of execution of sound reproduction corresponding to the predetermined audio signal SA by the speaker unit 7.

The control unit 3D performs a process which calculates coefficients used by the feedforward control unit 28 of the signal processing unit 4, i.e., by the first FF filter 22 and the second FF filter 23, to reduce a difference between an actual measurement characteristic corresponding to the vibration transfer characteristic calculated in the manner described above and a vibration transfer characteristic (reference characteristic) measured at the time of a reference time such as a factory shipment time, and sets the calculated coefficients for the first FF filter 22 and the second FF filter 23.

In this manner, compensation for a vibration transfer characteristic change over time and for an individual variation is achievable.

### 2. Second Embodiment

A second embodiment will next be described. The second embodiment relates to a GUI (Graphical User Interface) for presenting information regarding a measurement result of a vibration transfer characteristic to the user.

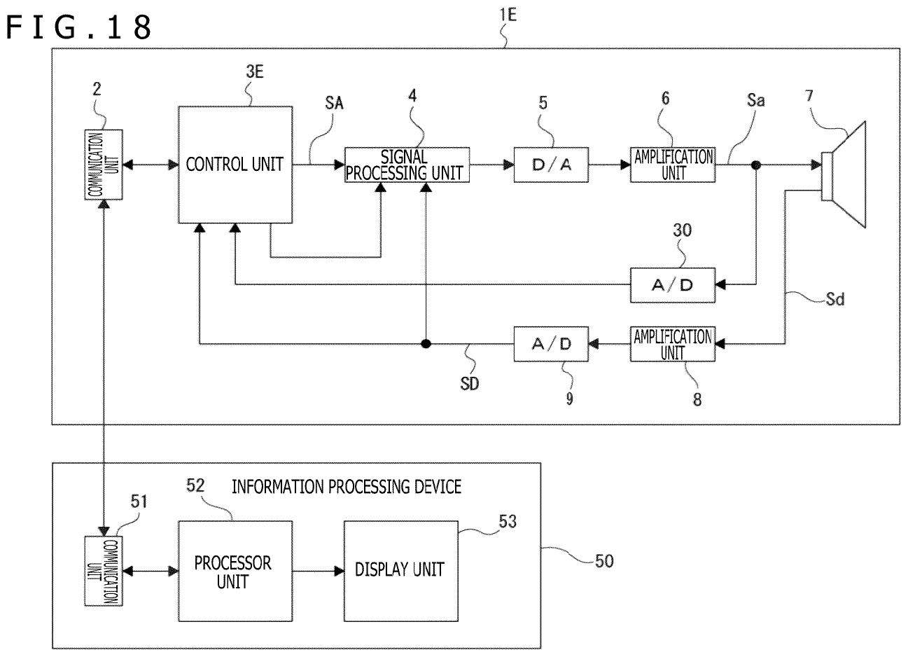

FIG. 18 is a diagram for explaining a configuration example of an audio reproduction system according to the second embodiment, and illustrates respective internal configuration examples of an audio device 1E and an information processing device 50 constituting this audio reproduction system.

The audio device 1E is different from the audio device 1D described above and illustrated in FIG. 17 in that a control unit 3E is provided instead of the control unit 3D. The control unit 3E is configured to perform a process for compensating for a vibration transfer characteristic change over time and an individual variation similarly to the control unit 3D. Moreover, the control unit 3E performs a process for transmitting information regarding a measured vibration transfer characteristic to the information processing device 50 via the communication unit 2 in response to a request from the information processing device 50.

For example, the information processing device 50 constitutes a computer device such as a smartphone, a tablet device, and a personal computer, and includes a communication unit 51, a processor unit 52, and a display unit 53 as illustrated in the figure. The processor unit 52 includes a CPU and a memory such as a ROM and a RAM, for example, and performs overall control of the information processing device, data communication with an external device (particularly, the audio device 1E in the present embodiment) via the communication unit 51, and other processing. Note that communication between the communication units 2 and 51 may be achieved by either wired communication or wireless communication.

For example, the display unit 53 constitutes an LCD (Liquid Crystal Display), an organic EL (Electroluminescence) display, or the like, and displays various types of information on a display screen 53a in response to instructions from the processor unit 52. Moreover, the display unit 53 is configured to display items to be presented by the GUI, such as various types of operation menus, icons, and messages, in response to instructions from the processor unit 52.

Note here that a management application (application program) for the audio device 1E is installed in the information processing device 50 to allow input of various operations, settings, and the like to the audio device 1E, for example. This management application enables the user to issue to the audio device 1E an instruction for executing the process of compensation for a vibration transfer characteristic described above. Moreover, this management application causes the processor unit 52 to perform a process for displaying information regarding a status of the audio device 1E, specifically, information regarding a measured vibration transfer characteristic, on the display screen 53a.

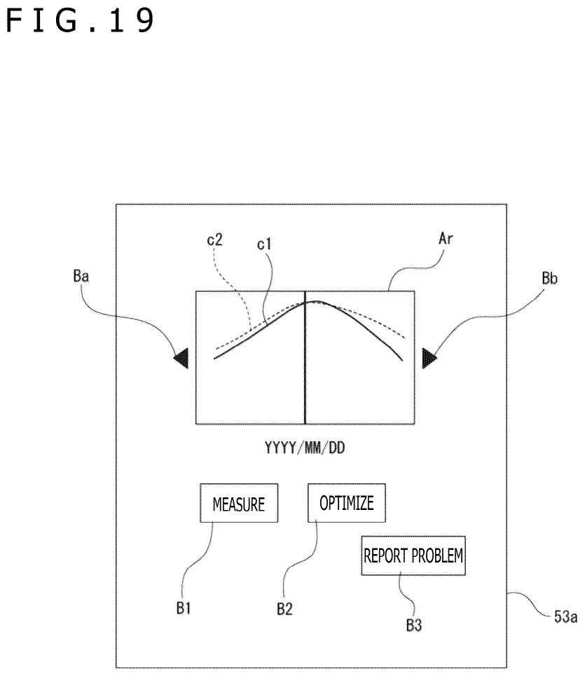

FIG. 19 illustrates an example of the GUI displayed on the display screen 53a.

As illustrated in the figure, the GUI in this case is configured to display a vibration transfer characteristic (e.g., compliance characteristic) measured by the audio device 1E in a measurement result display area Ar within the screen. A backward button Ba and a forward button Bb are displayed in the screen. The user operates these buttons to select a measurement result desired to be displayed from multiple measurement results. According to the present embodiment, a vibration transfer characteristic c2 is displayed in the measurement result display area Ar for comparison in addition to information indicating a measured vibration transfer characteristic c1. For example, the vibration transfer characteristic c2 displayed in this case may include an average value or the like of vibration transfer characteristics measured for multiple audio devices 1E at the time of factory shipment or other occasions.

Moreover, a measurement button B1 and an optimization button B2 are displayed in the screen. The buttons B1 and B2 function as an instruction button for executing measurement of a vibration transfer characteristic, and an instruction button for executing a process for compensating for a vibration transfer characteristic, respectively.

Note here that the processor unit 52 is also capable of detecting an abnormality in the vibration transfer system (diaphragm 10 and movable unit 11) of the audio device 1E, in reference to a measurement result of a vibration transfer characteristic obtained by the audio device 1E. In a case of detection of this abnormality, the processor unit 52 may carry out a process for displaying notification information as notification of this abnormality on the display screen 53a.

In addition, for example, a report button B3 illustrated in FIG. 19 by way of example may be provided to report occurrence of this abnormality to a manufacturer or the like in response to an operation by the user.

While the information processing device 50 includes the display unit 53 in the example described above, the display unit 53 may be externally attached to the information processing device 50.

Moreover, while the processor unit 52 performing the GUI display process is provided separately from the audio device 1E in the example described above, the GUI display process may be carried out by the control unit 3E of the audio device 1E.

Furthermore, the GUI display method is not limited to the example described above. For example, the GUI screen display (e.g., types and arrangements of various buttons, size adjustment and zoom-in/zoom-out of the measurement result display area Ar, etc.) may be changed by the user as desired.

In addition, pieces of measurement data regarding various models of headphones and earphones are acquirable by the present embodiment. Accordingly, measurement data acquired for each model is available as reference data for deterioration over time, for example. Besides, measurement data may be stored in a cloud, and shared with headphone or earphone design manufacturers, mold manufacturers, parts manufacturers, or the like. Measurement data may also be provided for the foregoing manufacturers for profit or non-profit via a cloud.

### 3. Modifications

The present technology is not limited to the specific examples described in the above embodiments of the present technology. Various other configurations may be adopted as modified examples.

For example, while described above has been the structure of the magnetic circuit unit compatible with the diaphragm 10 having a substantially circular shape in a top view, the shape of the diaphragm 10 in a top view is not limited to the substantially circular shape, and may be other shapes such as an elliptical shape, a polygonal shape, a quadrangular shape, and a triangular shape. Similarly, the shapes of the constituent elements of the magnetic circuit unit, such as the top plate portion 18 and the pole piece portion 19, are not limited to the annular shape and the circular shape presented by way of example, and may be other shapes.

Moreover, while the structure of the magnetic circuit unit of the present technology (the structure including the protrusion portion 18b and the first coil and the second coil which have the winding portions facing the protruding side surface) is applied to the movable coil-type speaker (audio reproduction device) in the example described above, the structure of the magnetic circuit unit according to the present technology is also applicable to a movable coil-type microphone.

The movable coil-type microphone is formed on the basis of a principle and a structure similar to those of the movable coil-type speaker. Accordingly, the structure of the magnetic circuit unit of the present technology is applicable to the movable coil-type microphone without change. In a certain use example, the first coil and the second coil both provided as input are input to individual A/D converters, and signals (sound collection signals) to be used are switched for each of a large amplitude time and a small amplitude time. In this manner, a dynamic range can be widened. In an alternative use example, one of the first and second coils may be used as the driving coil. In this case, the driving coil is controlled in such a manner as to move in a direction opposite to a movement direction of the diaphragm movable by an effect of a sound field. In this manner, distortion caused by excessive input can be reduced, for example. In addition, in a case of use of the driving coil in this manner, measurement of a vibration transfer characteristic and a compensation process for a vibration transfer characteristic change over time and an individual variation based on a measurement result may be carried out in a manner similar to the manner of the speaker.

Further, the present technology is also applicable to hearing aids (hearing devices) and sound collectors (specifically, speaker units of sound collectors).

Besides, while the distortion correction method performing feedforward control in addition to feedback control is applied to the audio device having the structure of the magnetic circuit unit of the present technology in the example described above, this distortion correction method is also applicable to an audio device not having the structure of the magnetic circuit unit of the present technology in a preferable manner.

### 4. Summary of Embodiments

As described above, a first audio device (audio device 1, 1D, 1E) according to the embodiment includes a diaphragm (diaphragm 10), a movable unit (movable unit 11) that includes a coil and connects with the diaphragm, and a magnetic circuit unit (magnetic circuit unit 15, 15A, 15B) that includes a magnet (magnet 16) and a yoke (yoke 17, 17A, 17B) and generates magnetic force acting on the coil. The magnetic circuit unit includes a top plate portion (top plate portion 18, 18A) that constitutes a part of the yoke and has a top surface portion (top surface portion 18a) located above the magnet and extending in a direction substantially perpendicular to a movable direction of the movable unit. The top plate portion has a protrusion portion (protrusion portion 18b) that protrudes downward from an inner edge or an outer edge of the top surface portion. The movable unit has a first coil and a second coil each constituting the coil. Winding portions of the first coil and the second coil of the movable unit face a protruding side surface (protruding side surface Su) that is a side surface of the top plate portion on a side where the protrusion portion is formed.

As described above, the protrusion portion is provided on the top plate portion, and the winding portions of the first coil and the second coil of the movable unit face the protruding side surface of the top plate portion. In this case, respective magnetic circuits for the first coil and the second coil can be formed by using a common magnet and a common yoke. In other words, a necessity of providing a magnet and a yoke for each of the coils can be eliminated.

Accordingly, this configuration can reduce a size increase and a weight increase of the movable coil-type audio device which includes multiple coils of the movable unit.

Moreover, according to the first audio device of the embodiment, one of the first and second coils is a driving coil for driving the diaphragm, and the other of the first and second coils is a sensing coil for detecting movement of the diaphragm.

This configuration can drive the diaphragm in reference to information regarding detected movement of the diaphragm.

Accordingly, this configuration is suitable for control for correcting distortion of the diaphragm, such as MFB control.

Moreover, the first audio device of the embodiment further includes a communication unit that communicates with an external device.

Accordingly, information regarding movement of the diaphragm can be transmitted to the external device in a case where one of the first and second coils is a sensing coil.

Further, the first audio device of the embodiment may be configured as a speaker device.

This configuration can reduce a size increase and a weight increase of the audio device which constitutes a speaker device performing MFB control.

Further, the first audio device of the embodiment may be configured as an earphone, a headphone, a hearing aid, or a sound collector.

This configuration can reduce a size increase and a weight increase of the audio device which constitutes an earphone, a headphone, a hearing aid, or a sound collector and includes the movable unit equipped with multiple coils.

Besides, according to the first audio device of the embodiment, the first coil and the second coil are supported by the same support body.

If a support body is individually provided for each of the first and second coils in such a manner that the first and second coils are wound around different bobbins, for example, a difference in movement is produced between the driving coil and the sensing coil. In this case, using the sensing coil to appropriately detect movement of the diaphragm is difficult. However, the configuration having the same support body for the first and second coils as described above eliminates the difference in movement between the driving coil and the sensing coil, and achieves appropriate detection of movement of the diaphragm by use of the sensing coil.

Accordingly, movement of the diaphragm is more accurately detectable by the sensing coil.

Moreover, according to the first audio device of the embodiment, the first coil and the second coil are wound around the same bobbin (bobbin 12).

In this case, the first and second coils are supported by the same support body, and a difference in movement is eliminated between the driving coil and the sensing coil.

Accordingly, movement of the diaphragm is more accurately detectable by the sensing coil.

Further, according to the first audio device of the embodiment, the first coil and the second coil are wound in opposite directions.

In this case, electromotive force generated in the sensing coil by movement of the movable unit and electromotive force generated in the sensing coil by a flow of driving current in the driving coil have opposite polarities.

Accordingly, a variation width of voltage of the sensing signal generated by the sensing coil at the time of movement of the movable unit can be reduced.

Besides, according to the first audio device of the embodiment, the first coil and the second coil are wound away from each other in a vertical direction.

This configuration reduces electromotive force generated in the sensing coil by a flow of driving current in the driving coil.

Accordingly, movement of the diaphragm is more accurately detectable by the sensing coil.

In addition, separation between the first coil and the second coil can prevent overlap between the driving coil and a region having a magnetic flux density distribution characteristic for sensing in the magnetic circuit unit, or opposite overlap, i.e., overlap between the sensing coil and a region having a magnetic flux density distribution characteristic for driving.

Accordingly, improvement of driving efficiency and driving performance of the diaphragm and improvement of detection accuracy of movement of the diaphragm are both achievable.

Moreover, according to the first audio device of the embodiment, the driving coil is wound outside a lead wire of the sensing coil, and the sensing coil including the lead wire has a smaller thickness than the driving coil.

This configuration can reduce a protrusion length of an outwardly protruding portion included in the driving coil and protruding outward as a result of wiring of the lead wire of the sensing coil inside the driving coil.

This configuration can thus shorten a clearance width required between the driving coil and the yoke, and reduce a magnetic gap of the driving coil. Accordingly, driving efficiency of the diaphragm improves.

Furthermore, according to the first audio device of the embodiment, the first coil and the second coil are wound as one body by a bobbinless winding method.

This configuration can reduce the size and the weight of the device by removal of the bobbin.

Besides, according to the first audio device of the embodiment, the magnetic circuit unit is an internal magnetic-type magnetic unit or an external magnetic-type magnetic circuit unit (magnetic circuit unit 15A, 15).

This configuration can reduce a size increase and a weight increase of the audio device which has an internal magnetic-type or external magnetic-type magnetic circuit unit and includes the movable unit having multiple coils.

Moreover, according to the first audio device of the embodiment, the magnetic circuit unit is an internal/external magnetic-type magnetic circuit unit (magnetic circuit unit 15B).

This configuration can reduce a size increase and a weight increase of the audio device which has an internal/external magnetic-type magnetic circuit unit, and includes the movable unit having multiple coils.

Further, the first audio device of the embodiment further includes an electric circuit unit (signal processing unit 4, 4C) that generates a driving signal for the driving coil according to a sensing signal generated by the sensing coil.

This configuration achieves signal processing for correcting distortion of the diaphragm, such as MFB control.

Besides, according to the first audio device of the embodiment, the electric circuit unit includes a feedback control unit (feedback control unit 27, 27C) that processes an audio signal by using a feedback loop to which the sensing signal is input and a feedforward control unit (feedforward control unit 28) that performs arithmetic processing using a predetermined coefficient for the audio signal input to the feedback loop.

This configuration includes the feedforward control unit in addition to the feedback control unit which performs feedback control according to sensing signals of the sensing coil similarly to conventional MFB control. In this case, distortion not corrected by the feedback control unit alone is correctable.

Accordingly, distortion correction accuracy improves.

Moreover, according to the first audio device of the embodiment, the magnetic circuit unit has a characteristic that has a peak of r-direction magnetic flux density around a winding portion of the driving coil and has a flat distribution of the r-direction magnetic flux density around a winding portion of the sensing coil (see FIG. 11).

Accordingly, the magnetic flux density distributions appropriate for the purposes of the coils can be provided for the respective regions containing the coils without providing the magnet and the yoke for each of the coils.

A second audio device (audio device 1, 1D, 1E) according to the embodiment includes a diaphragm (diaphragm 10), a movable unit (movable unit 11) that includes a driving coil (driving coil 13) for driving the diaphragm and a sensing coil (sensing coil 14) for detecting movement of the diaphragm and connects with the diaphragm, a magnetic circuit unit (magnetic circuit unit 15, 15A, 15B) that includes a magnet (magnet 16) and a yoke (yoke 17, 17A, 17B) and generates magnetic force acting on the driving coil and magnetic force acting on the sensing coil, and an electric circuit unit (signal processing unit 4, 4C) that generates a driving signal of the driving coil according to a sensing signal generated by the sensing coil. The electric circuit unit includes a feedback control unit (feedback control unit 27, 27C) that has a feedback loop for processing an audio signal according to the sensing signal and a feedforward control unit (feedforward control unit 28) that performs arithmetic processing using a predetermined coefficient for the audio signal input to the feedback loop.

This configuration includes the feedforward control unit in addition to the feedback control unit which performs feedback control according to sensing signals of the sensing coil as in conventional MFB control. In this case, distortion not corrected by the feedback control unit alone is correctable.

Accordingly, distortion correction accuracy improves.

Moreover, according to the second audio device of the embodiment, the feedback control unit (feedback control unit 27C) includes a conversion filter unit (conversion filter 31) that generates, according to a driving signal of the driving coil, a signal for cancelling an error produced in the sensing signal by magnetic coupling between the driving coil and the sensing coil (see FIG. 16).

In this manner, an effect by the magnetic coupling from the driving coil to the sensing coil can be appropriately eliminated, and hence, movement of the diaphragm is more accurately detectable.

Moreover, a signal processing method according to the embodiment is a signal processing method for an audio device that includes a diaphragm, a movable unit that includes a driving coil for driving the diaphragm and a sensing coil for detecting movement of the diaphragm and connects with the diaphragm, a magnetic circuit unit that includes a magnet and a yoke and generates magnetic force acting on the driving coil and magnetic force acting on the sensing coil, and an electric circuit unit that generates a driving signal of the driving coil according to a sensing signal generated by the sensing coil. The electric circuit unit performs feedback control that processes an audio signal by using a feedback loop to which the sensing signal is input and feedforward control that performs arithmetic processing using a predetermined coefficient for the audio signal input to the feedback loop.

Such a signal processing method can achieve operations and effects similar to those of the second audio device described above.

Moreover, a display method according to the embodiment is a display method for an audio device that includes a diaphragm, a movable unit that includes a coil and connects with the diaphragm, and a magnetic circuit unit that includes a magnet and a yoke and generates magnetic force acting on the coil. The magnetic circuit unit includes a top plate portion that constitutes a part of the yoke and has a top surface portion located above the magnet and extending in a direction substantially perpendicular to a movable direction of the movable unit. The top plate portion has a protrusion portion that protrudes downward from an inner edge or an outer edge of the top surface portion. The movable unit includes a driving coil for driving the diaphragm and a sensing coil for detecting movement of the diaphragm each constituting the coil. Winding portions of the driving coil and the sensing coil of the movable unit face a protruding side surface that is a side surface of the top plate portion on a side where the protrusion portion is formed. The display method displays information that indicates a vibration transfer characteristic associated with the audio device and measured according to a detection signal generated by the sensing coil.

Such a display method can present to the user information regarding the vibration transfer characteristic measured according to the detection signal generated by the sensing coil included in the audio device of the embodiment.

Note that advantageous effects to be offered are not limited to those in the present description presented only by way of example. Other advantageous effects may be additionally produced.

### 5. Present Technology

The present technology can also take the following configurations.

(1)

An audio device including:
a diaphragm;
a movable unit that includes a coil and connects with the diaphragm; and
a magnetic circuit unit that includes a magnet and a yoke and generates magnetic force acting on the coil,
in which the magnetic circuit unit includes a top plate portion that constitutes a part of the yoke and has a top surface portion located above the magnet and extending in a direction substantially perpendicular to a movable direction of the movable unit,
the top plate portion has a protrusion portion that protrudes downward from an inner edge or an outer edge of the top surface portion,
the movable unit has a first coil and a second coil each constituting the coil, and
winding portions of the first coil and the second coil of the movable unit face a protruding side surface that is a side surface of the top plate portion on a side where the protrusion portion is formed.
   (2)

The audio device according to (1) above, in which one of the first and second coils is a driving coil for driving the diaphragm, and the other of the first and second coils is a sensing coil for detecting movement of the diaphragm.

(3)

The audio device according to (2) above, further including:
a communication unit that communicates with an external device.
   (4)

The audio device according to (2) or (3) above, in which the audio device is configured as a speaker device.

(5)

The audio device according to (4) above, in which the audio device is configured as an earphone, a headphone, a hearing aid, or a sound collector.

(6)

The audio device according to any one of (2) through (5) above, in which the first coil and the second coil are supported by the same support body.

(7)

The audio device according to (6) above, in which the first coil and the second coil are wound around the same bobbin.

(8)

The audio device according to (6) or (7) above, in which the first coil and the second coil are wound in opposite directions.

(9)

The audio device according to (7) or (8) above, in which the first coil and the second coil are wound away from each other in a vertical direction.

(10)

The audio device according to any one of (7) through (9) above,
in which the driving coil is wound outside a lead wire of the sensing coil, and
the sensing coil including the lead wire has a smaller thickness than the driving coil.
   (11)

The audio device according to (6) above, in which the first coil and the second coil are wound as one body by a bobbinless winding method.

(12)

The audio device according to any one of (1) through (11) above, in which the magnetic circuit unit is an internal magnetic-type magnetic circuit unit or an external magnetic-type magnetic circuit unit.

(13)

The audio device according to any one of (1) through (11) above, in which the magnetic circuit unit is an internal/external magnetic-type magnetic circuit unit.

(14)

The audio device according to any one of (2) through (13) above, further including:
an electric circuit unit that generates a driving signal for the driving coil according to a sensing signal generated by the sensing coil.
   (15)

The audio device according to (14) above, in which the electric circuit unit includes a feedback control unit that processes an audio signal by using a feedback loop to which the sensing signal is input and a feedforward control unit that performs arithmetic processing using a predetermined coefficient for the audio signal input to the feedback loop.

(16)

The audio device according to any one of (2) through (15) above, in which the magnetic circuit unit has a characteristic that has a peak of r-direction magnetic flux density around a winding portion of the driving coil and has a flat distribution of the r-direction magnetic flux density around a winding portion of the sensing coil.

(17)

An audio device including:
a diaphragm;
a movable unit that includes a driving coil for driving the diaphragm and a sensing coil for detecting movement of the diaphragm and connects with the diaphragm;
a magnetic circuit unit that includes a magnet and a yoke and generates magnetic force acting on the driving coil and magnetic force acting on the sensing coil; and
an electric circuit unit that generates a driving signal of the driving coil according to a sensing signal generated by the sensing coil,
in which the electric circuit unit includes a feedback control unit that has a feedback loop for processing an audio signal according to the sensing signal and a feedforward control unit that performs arithmetic processing using a predetermined coefficient for the audio signal input to the feedback loop.
   (18)

The audio device according to (17) above, in which the feedback control unit includes a conversion filter unit that generates, according to a driving signal of the driving coil, a signal for cancelling an error produced in the sensing signal by magnetic coupling between the driving coil and the sensing coil.

(19)

A signal processing method for an audio device,
the audio device including
   a diaphragm,
   a movable unit that includes a driving coil for driving the diaphragm and a sensing coil for detecting movement of the diaphragm and connects with the diaphragm,
   a magnetic circuit unit that includes a magnet and a yoke and generates magnetic force acting on the driving coil and magnetic force acting on the sensing coil, and
   an electric circuit unit that generates a driving signal of the driving coil according to a sensing signal generated by the sensing coil,
the signal processing method including:
by the electric circuit unit,
performing feedback control that processes an audio signal by using a feedback loop to which the sensing signal is input and feedforward control that performs arithmetic processing using a predetermined coefficient for the audio signal input to the feedback loop.
   (20)

A display method for an audio device,
the audio device including
   a diaphragm,
   a movable unit that includes a coil and connects with the diaphragm, and
   a magnetic circuit unit that includes a magnet and a yoke and generates magnetic force acting on the coil,
the magnetic circuit unit including a top plate portion that constitutes a part of the yoke and has a top surface portion located above the magnet and extending in a direction substantially perpendicular to a movable direction of the movable unit,
the top plate portion having a protrusion portion that protrudes downward from an inner edge or an outer edge of the top surface portion,
the movable unit including a driving coil for driving the diaphragm and a sensing coil for detecting movement of the diaphragm each constituting the coil, and
winding portions of the driving coil and the sensing coil of the movable unit facing a protruding side surface that is a side surface of the top plate portion on a side where the protrusion portion is formed,
the display method including:
displaying information that indicates a vibration transfer characteristic associated with the audio device and measured according to a detection signal generated by the sensing coil.

### REFERENCE SIGNS LIST

1, 1D, 1E: Audio device
3, 3D, 3E: Control unit
4, 4C: Signal processing unit
5: D/A converter
6, 8: Amplification unit
7: Speaker unit
9: A/D converter
10: Diaphragm
11: Movable unit
12: Bobbin
13: Driving coil
14: Sensing coil
15, 15A, 15B: Magnetic circuit unit
16: Magnet
17, 17A, 17B: Yoke
18, 18A: Top plate portion
18a: Top surface portion
18b: Protrusion portion
19, 19A, 19B: Pole piece portion
19a: Bottom portion
19b: Wall portion
Su: Protruding side surface
Si: Facing surface
L13, L14: Lead wire
O: Outwardly protruding portion
G: Gap
22: First FF filter
23: Second FF filter
24, 26: Adder
25: FB filter
27, 27C: Feedback control unit
28: Feedforward control unit
30: A/D converter
31: Conversion filter
32: Subtractor

1. An audio device comprising:
a diaphragm;
a movable unit that includes a coil and connects with the diaphragm; and
a magnetic circuit unit that includes a magnet and a yoke and generates magnetic force acting on the coil,
wherein the magnetic circuit unit includes a top plate portion that constitutes a part of the yoke and has a top surface portion located above the magnet and extending in a direction substantially perpendicular to a movable direction of the movable unit,
the top plate portion has a protrusion portion that protrudes downward from an inner edge or an outer edge of the top surface portion,
the movable unit has a first coil and a second coil each constituting the coil, and
winding portions of the first coil and the second coil of the movable unit face a protruding side surface that is a side surface of the top plate portion on a side where the protrusion portion is formed.

2. The audio device according to claim 1, wherein one of the first and second coils is a driving coil for driving the diaphragm, and the other of the first and second coils is a sensing coil for detecting movement of the diaphragm.

3. The audio device according to claim 2, further comprising:
a communication unit that communicates with an external device.

4. The audio device according to claim 2, wherein the audio device is configured as a speaker device.

5. The audio device according to claim 4, wherein the audio device is configured as an earphone, a headphone, a hearing aid, or a sound collector.

6. The audio device according to claim 2, wherein the first coil and the second coil are supported by a same support body.

7. The audio device according to claim 6, wherein the first coil and the second coil are wound around a same bobbin.

8. The audio device according to claim 6, wherein the first coil and the second coil are wound in opposite directions.

9. The audio device according to claim 7, wherein the first coil and the second coil are wound away from each other in a vertical direction.

10. The audio device according to claim 7,
wherein the driving coil is wound outside a lead wire of the sensing coil, and
the sensing coil including the lead wire has a smaller thickness than the driving coil.

11. The audio device according to claim 6, wherein the first coil and the second coil are wound as one body by a bobbinless winding method.

12. The audio device according to claim 1, wherein the magnetic circuit unit is an internal magnetic-type magnetic circuit unit or an external magnetic-type magnetic circuit unit.

13. The audio device according to claim 1, wherein the magnetic circuit unit is an internal/external magnetic-type magnetic circuit unit.

14. The audio device according to claim 2, further comprising:
an electric circuit unit that generates a driving signal for the driving coil according to a sensing signal generated by the sensing coil.

15. The audio device according to claim 13, wherein the electric circuit unit includes a feedback control unit that processes an audio signal by using a feedback loop to which the sensing signal is input and a feedforward control unit that performs arithmetic processing using a predetermined coefficient for the audio signal input to the feedback loop.

16. The audio device according to claim 2, wherein the magnetic circuit unit has a characteristic that has a peak of r-direction magnetic flux density around a winding portion of the driving coil and has a flat distribution of the r-direction magnetic flux density around a winding portion of the sensing coil.

17. An audio device comprising:
a diaphragm;
a movable unit that includes a driving coil for driving the diaphragm and a sensing coil for detecting movement of the diaphragm and connects with the diaphragm;
a magnetic circuit unit that includes a magnet and a yoke and generates magnetic force acting on the driving coil and magnetic force acting on the sensing coil; and
an electric circuit unit that generates a driving signal of the driving coil according to a sensing signal generated by the sensing coil,
wherein the electric circuit unit includes a feedback control unit that has a feedback loop for processing an audio signal according to the sensing signal and a feedforward control unit that performs arithmetic processing using a predetermined coefficient for the audio signal input to the feedback loop.

18. The audio device according to claim 17, wherein the feedback control unit includes a conversion filter unit that generates, according to a driving signal of the driving coil, a signal for cancelling an error produced in the sensing signal by magnetic coupling between the driving coil and the sensing coil.

19. A signal processing method for an audio device,
the audio device including
a diaphragm,
a movable unit that includes a driving coil for driving the diaphragm and a sensing coil for detecting movement of the diaphragm and connects with the diaphragm,
a magnetic circuit unit that includes a magnet and a yoke and generates magnetic force acting on the driving coil and magnetic force acting on the sensing coil, and
an electric circuit unit that generates a driving signal of the driving coil according to a sensing signal generated by the sensing coil,
the signal processing method comprising:
by the electric circuit unit,
performing feedback control that processes an audio signal by using a feedback loop to which the sensing signal is input and feedforward control that performs arithmetic processing using a predetermined coefficient for the audio signal input to the feedback loop.

20. A display method for an audio device,
the audio device including
a diaphragm,
a movable unit that includes a coil and connects with the diaphragm, and
a magnetic circuit unit that includes a magnet and a yoke and generates magnetic force acting on the coil,
the magnetic circuit unit including a top plate portion that constitutes a part of the yoke and has a top surface portion located above the magnet and extending in a direction substantially perpendicular to a movable direction of the movable unit,
the top plate portion having a protrusion portion that protrudes downward from an inner edge or an outer edge of the top surface portion,
the movable unit including a driving coil for driving the diaphragm and a sensing coil for detecting movement of the diaphragm each constituting the coil, and
winding portions of the driving coil and the sensing coil of the movable unit facing a protruding side surface that is a side surface of the top plate portion on a side where the protrusion portion is formed,
the display method comprising:
displaying information that indicates a vibration transfer characteristic associated with the audio device and measured according to a detection signal generated by the sensing coil.
